(19) United States
(12) Patent Application Publication
(10) Pub. No.: US 2003/0004662 A1
(43) Pub. Date: Jan. 2, 2003

(54) Method and system for managing battery power for battery powered devices

(75) Inventors: Michael K. Mitchell, Frisco, TX (US); Jason G. Cole, Carrollton, TX (US)

Correspondence Address: Hsin-Wei Luang, Jenkens & Gilchrist, A Professional Corporation, 3200 Fountain Place, 1445 Ross Avenue, Dallas, TX, 75202-2799, US

(73) Assignee: Dallas Semiconductor Corporation

(21) Appl. No.: 09/882,575

(22) Filed: Jun. 14, 2001

(51) Int. Cl. G06F 19/00

(52) U.S. Cl. 702/63

(57) ABSTRACT

A battery power management system comprising a system processor, a fuel gauge algorithm running on the system processor, at least one battery fuel cell electrically connected to the system processor, a battery data collector electrically connected to the battery fuel cell, with the battery data collector collecting electrical power data from the battery fuel cell and transmitting the electrical power data to the fuel gauge algorithm, where said fuel gauge algorithm converts the electrical power data to active and standby battery power information.

### BACKGROUND OF THE INVENTION

1. Technical Field of the Invention

The present invention relates in general to battery power management and, in particular, to a system and method for managing battery power for battery powered devices.

2. Description of Related Art

Many modern day electronic or electro-mechanical devices such as cell phones, calculators, personal digital assistants (PDAs), electric vehicles and so forth are battery powered devices. While these devices tend to make life easier for their users, the need to replenish their battery power can be extremely inconvenient at times. If a user is not careful, the battery power of such a device may run out while the device is in operation and must be recharged or replaced before the device can operate again. Further, if the battery dies while the device is in operation, crucial user-entered data may be lost forever. Not being able to use the battery powered device at crucial times or the possibility of losing data entered into the device all discourage people from using these battery powered devices. Therefore, there has been a long time need in the marketplace for a system and method that can keep track of the amount of power left in a battery so a user of a battery powered device can conveniently schedule battery recharge time or obtain appropriate replacement battery before the battery power runs out.

One way currently used to determine battery power level is through power test strips. These power test strips are sold in the marketplace along with disposable batteries such as Energizer® brand batteries of the Eveready Battery Company, Inc. A user simply holds one end of the test strip to the positive end of the battery and another end of the test strip to the negative end of the battery. By pressing the ends of the test strip to the battery, a user can determine the amount of power left in the battery when an electro-chemical process changes a portion of the test strip's color, forming a bar graph indicating the amount of power left in the battery.

Another way currently used to determine battery power level is through different types of visual displays on the battery powered device itself This second way of indicating battery power level is generally used with battery powered devices powered by rechargeable batteries. Such devices include, but are not limited to, cell phones and PDAs. Remaining battery power is often shown on the display windows of these devices as, for example, a bar graph without indication of units of measurement. Without units of measurement, the bar graph only tells relative battery power, and cannot tell the exact amount of battery power left. Since the power drainage rate of a battery changes depending on whether the device is in active mode or standby mode and depending on the temperature of the device, the bar graph does not give a very accurate picture of remaining battery power. For example, while the bar graph may indicate plenty of power left when the device is in standby mode, a user may be unpleasantly surprised when the same device is activated and the battery power is quickly drained in but a few minutes. In this case, the low power warning comes too late and the user is inconvenienced by an inoperable battery powered device with a dead battery.

Still another way currently used to determine battery power level is through a low power warning that appears when the battery is about to become fully drained. For example, some calculators display a low battery warning a few hours before the battery is to run out. However, this type of low battery warning cannot tell the user whether the battery has two hours or two minutes of power left. Thus, this third method of indicating battery power is also inconvenient for the user.

Much of the reason behind the difficulty in predicting remaining battery power in these prior art devices lies in the fact that, in these prior art devices, the remaining battery power is calculated based on the voltage change of the battery. Voltage change, however, is not linear over the entire discharge time of the battery. With battery power also dependent on the operating temperature of the device, it becomes very difficult to accurately predict the remaining battery power.

Therefore, a new and improved method and system for managing battery power of battery powered devices is needed.

### SUMMARY OF THE INVENTION

The present invention is a system and method for managing battery power of battery powered devices. The invention can be divided into a product portion and a battery pack portion. The product portion may be a cell phone, a PDA, an MP3 player, an electric vehicle, or any other battery-powered electronic or electromechanical device. The battery powered device's battery power management system has a system processor that runs a battery fuel gauge algorithm. The battery power management system also has at least one battery fuel cell electrically connected to the system processor. A battery data collector is electrically connected to the battery fuel cell, collects electrical power data from the battery cell, and transmits the electrical power data to the fuel gauge algorithm, where the electrical power data is converted to active and standby battery power information using a combination of the coulomb counting method and actual battery fuel cell data.

### BRIEF DESCRIPTION OF THE DRAWINGS

A more complete understanding of the method and apparatus of the present invention may be had by reference to the following detailed description when taken in conjunction with the accompanying drawings wherein:

FIG. 1a is a perspective view of an electronic portable device using a prior art method for displaying remaining battery power;

FIG. 1b is a perspective view of a portable device using the battery power managing method and system of the present invention;

FIG. 2 is a graphical representation of the battery power management system of the present invention;

FIG. 3 is a flow chart describing the method for battery power management of the present invention,

FIG. 4 is a flow chart describing the FPINIT portion of the algorithm that is an embodiment of the present invention;

FIG. 5 is a flow chart describing the FPUPDATE portion of the algorithm that is an embodiment of the present invention;

FIG. 6 is a flow chart describing the FPEMPTY portion of the algorithm that is an embodiment of the present invention;

FIG. 7 is a flow chart describing the FPFULL portion of the algorithm that is an embodiment of the present invention; and

FIG. 8 is a flow chart describing the FPLEARN portion of the algorithm that is an embodiment of the present invention.

### DETAILED DESCRIPTION OF THE DRAWINGS

The present invention is a system and method for battery power management. The method and system of the present invention can be used on any battery powered device such as, but not limited to, cell phones, PDAs, calculators, MP3 players, electric vehicles and so forth. However, for illustration purposes, the following detailed description will describe the present invention as being used on a cell phone. It should be understood that the present invention can easily be applied to other battery powered devices.

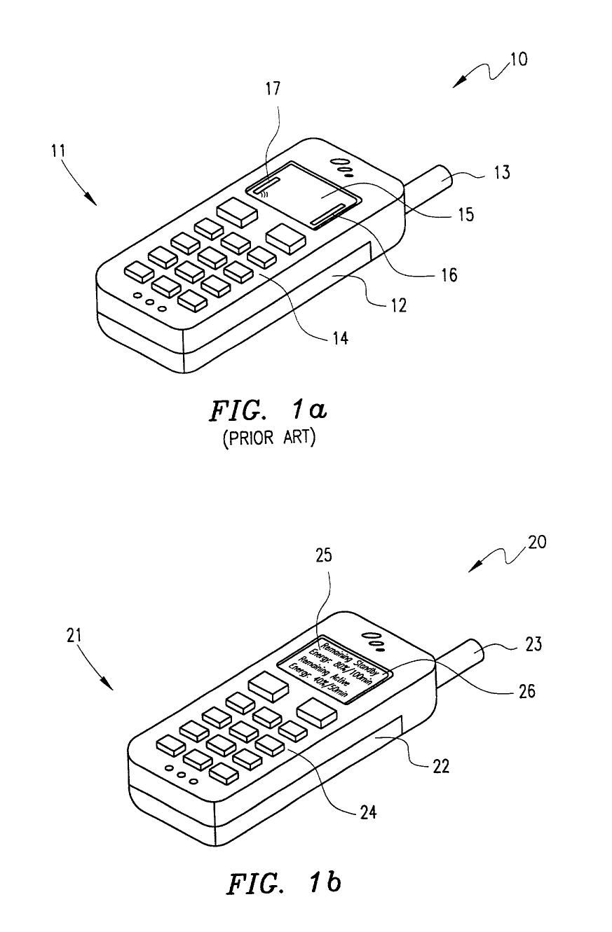

FIG. 1a is a perspective view of cell phone 10 that uses a prior art battery power management system and method. Cell phone 10 generally has a casing 11, a battery pack 12 that is removably attached to casing 11, and an antenna 13 that is also attached to casing 11. Casing 11 has a data entry interface 14 and a data display 15. Data entry interface 14 has various alphanumeric entry keys as well as soft keys for scrolling through various menu features of cell phone 10. The various cell phone functions are displayed on data display 15. For example, a battery power bar graph 16 and a signal strength bar graph 17—both displayed without measurement units—are shown on cell phone 10. Battery power bar graph 16 is a simple bar graph and does not indicate the precise amount of battery power available nor does it indicate the precise length of active or standby time remaining in the battery pack 12.

FIG. 1b shows a perspective view of a cell phone 20 using the battery power management system of the present invention. Cell phone 20 has a casing 21, a battery pack 22 that is removably attached to casing 21, and an antenna 23 that is also attached to casing 21 Casing 21 also has a data entry interface 24 with various soft key and alphanumeric data entry buttons for dialing the cell phone and/or for performing other data entry or menu manipulation tasks. Information entered from the data entry interface 24 or received from other sources can be displayed on data display 25. FIG. 1b shows battery power information 26 being displayed on data display 25. The battery power information 26 may include remaining standby energy in percent and/or minutes and/or the remaining active energy in percent and/or minutes. The units of measurement of time or energy may change over the discharge time of the battery. For example, battery power information 26 may first be displayed in units of hours of battery power left. At, for example, two hours of battery power until full drainage, the display may automatically change to minutes of battery power left. Additionally, embodiments of the present invention can display simple information as does the prior art device of FIG. 1, even though much more complex or detailed information is available.

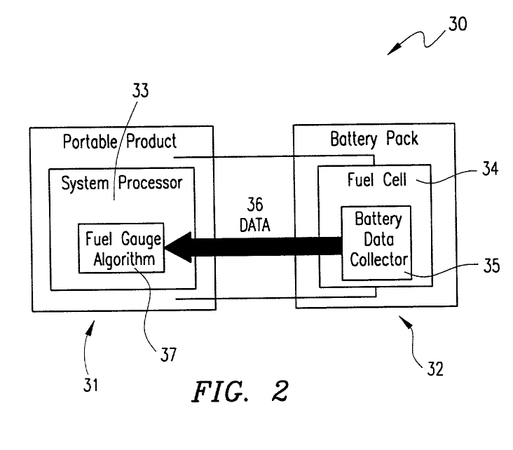

FIG. 2 is a graphical representation of the system and method for managing battery power of the present invention. Power management system 30 generally has a portable product portion 31 and a battery pack portion 32. A system processor 33 is located in the portable product portion 31. In addition to being used for managing battery power in accordance with the teachings of the present invention, system processor 33 is also used to run one or more programs or subroutines controlling the other aspects of cell phone 20 operation. Fuel cells 34 are located in the battery pack portion 32. Though only one fuel cell is shown in FIG. 2, it should be understood that the battery pack portion 32 may contain a plurality of fuel cells. In this embodiment of the present invention, a battery pack data collector 35 is also located in the battery pack portion 32. Though FIG. 2 shows battery data collector 35 placed on cells 34, it should be understood that the physical location of battery data collector 35 is unimportant so long as it can collect battery fuel data 36 of fuel cell 34. The battery data collector 35 collects battery fuel data 36 and sends the battery fuel data 36 to a fuel gauge algorithm 37 located in the system processor 33. Alternatively, or in addition, the battery data collector 35 can store the collected battery fuel data 36 and send the battery fuel data 36 to the fuel gauge algorithm 37 at a later time and/or it can otherwise transmit stored data. The fuel gauge algorithm 37 converts the battery fuel data 36 into active and standby battery fuel information. Fuel gauge algorithm 37 is a part of the software used to operate cell phone 20.

The system processor 33 of the portable product portion 31 can be any computer processor typically used in battery powered products. These system processors are readily available in the marketplace and therefore will not be described in further detail in this disclosure. System processor 33 should be able to run computer programs including a program running the fuel gauge algorithm 33, which will be described in more detail later below.

The battery data collector 35 may be located in the battery pack portion 32 of cell phone 20 The battery data collector 35 collects battery fuel data 36 of cell 34 by tracking the net current flow into and out of cell 34, by measuring the voltage of the battery pack portion 32, and by measuring the temperature of battery pack portion 32. Battery data collector 35 has a memory device used to store the measured battery fuel data 36 before the battery fuel cell data 36 is transmitted to the fuel gauge algorithm 37 located in system processor 33. The memory device of battery data collector 35 can be, but is not necessarily limited to, an EEPROM Many data collection devices currently available in the marketplace can be used as the battery data collector 35 of the present invention. For example, battery data collector 35 can be the High Precision Li-Ion Battery Monitor DS2760 manufactured by Dallas Semiconductor. However, other equivalent devices can also be used.

The memory device of the battery data collector 35 can store at least two types of data—real time battery power data and semi-permanent battery characteristic data. The real time battery power data can include, but is not limited to, net current flow into and out of cell 34, voltage drop across battery pack portion 32, and real-time temperature measurement of battery pack portion 32. The real time battery power data usually changes each time battery power information is sampled and is generally used to calculate the latest battery power of information in conjunction with the semi-permanent battery characteristic data.

Unlike the real time battery power data, the semi-permanent battery characteristic data does not change every time the battery power information is sampled. The semi-permanent characteristic data contains at least the various battery full and battery empty points matched with a full range of different temperatures. The initial battery fill and battery empty points are preferably first obtained experimentally and stored in the battery data collector 35. Battery full and battery empty points are necessary because, since rechargeable batteries become gradually full and gradually empty, there must be a defined point where, for various battery maintenance purposes, the battery powered device must know whether the battery is full or empty. Artificially defined yet definite fully charged and fully empty points allow the battery powered device to know when the battery is fill or empty Since battery capacity is temperature and rate dependent, each battery full and battery empty point is associated with a specific temperature and stored in the battery data collector 35.

The semi-permanent battery characteristic data is occasionally changed. As rechargeable batteries age, the battery loses its ability to store charge. Thus, battery full and battery empty points must be redefined periodically and then stored as new semi-permanent characteristic data, replacing the old semi-permanent characteristic data. Various methods of determining the new battery full and battery empty points exist and any one of which can be used for the present invention. However, for illustration purposes, one method of determining new semi-permanent characteristic data will be disclosed later below.

The software that forms a part of the system and method of the present invention runs on system processor 33 in the portable product portion 31 of the cell phone 20. Fuel gauge algorithm 37 may be a part of the main operations software of cell phone 20. The main program of the software may control other cell phone functions such as, but not limited to, processing the incoming and outgoing voice data, dialing the cell phone 20, displaying caller ID, and performing various other typical cell phone functions. Either the fuel gauge algorithm or the main program can control displaying the fuel cell power information on the data display 25 of cell phone 20. The fuel cell power information may include, but is not limited to, percent of power available if cell phone 20 is in standby and/or active mode, time until full power drainage of battery pack 22 if cell phone 20 is in active mode and/or standby mode, and any other battery power related information. The display can also appear in different measurement units, with the measurement units able to change as time passes. For example, the remaining battery power can first be displayed in units of hours. As battery power becomes depleted to a certain point—for example, to two hours of battery power left—the display may switch to units of minutes. The battery power information can be displayed periodically, constantly, and/or whenever requested by the user.

The fuel gauge algorithm 37, as has already been described above, can easily be written by one skilled in the art, based upon the foregoing teachings. For illustration purposes, however, one embodiment of such an algorithm will be disclosed below. It should be noted that the embodiment disclosed below is not the only method to carry out the present invention. Rather, any equivalent algorithm that can be written by one skilled in the art should be viewed as a part of the present invention.

In one embodiment of the present invention, the fuel gauge algorithm 37 is written as one computer program function that can perform one of five different tasks. The function is called from the main computer program, with the main computer program instructing the function on which one of the five tasks to perform. Note the fuel gauge algorithm 37 can also be constructed as five separate functions, with each one of the functions capable of being called by the main program at the appropriate time. The five tasks that can be performed by the fuel gauge algorithm 37 are FPINIT, FPUPDATE, FPEMPTY, FPFULL, and FPLEARN. Table 1 below shows a brief summary of the operation performed by FPINIT, FPUPDATE, FPEMPTY, EPFULL, and FPLEARN.

TABLE 1
Fuel Algorithm Tasks

| NAME | TASK |
|---|---|
| FPINIT | Initializes variables |
| FPUPDATE | Calculates battery information |
| FPEMPTY | Resets fuel gauge reading to 0% |
| FPFULL | Resets fuel gauge reading to 100% |
| FPLEARN | Resets expected battery full point |
| | reading in semi-permanent data |

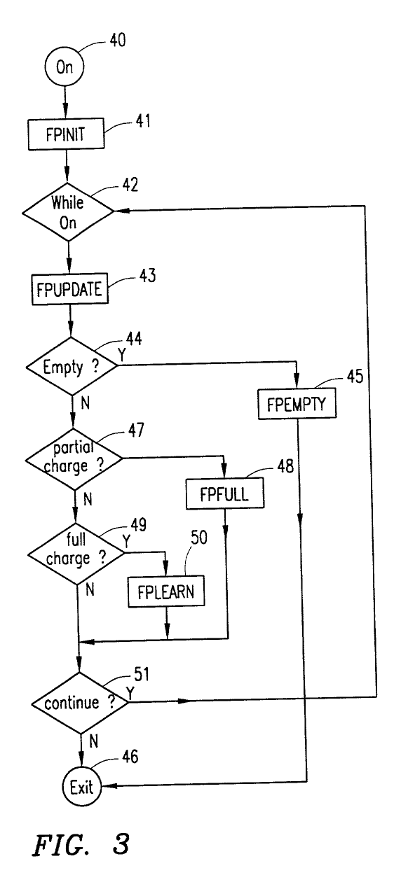

FIG. 3 shows a flowchart summarizing at what point each task is to be called by the main program FPINIT is called before any of the other tasks are called. The precise order for checking for the condition precedent before calling FPEMPTY, FPFULL, or FPLEARN is unimportant, and the order does not necessarily have to be the same as those shown in FIG. 3.

Referring to FIG. 3, the main program calls FPINIT one time after cell phone 20 is powered up. FPINIT is not called again until cell phone 20 is shut down and then reactivated or until a change in the power supply to the system is made.

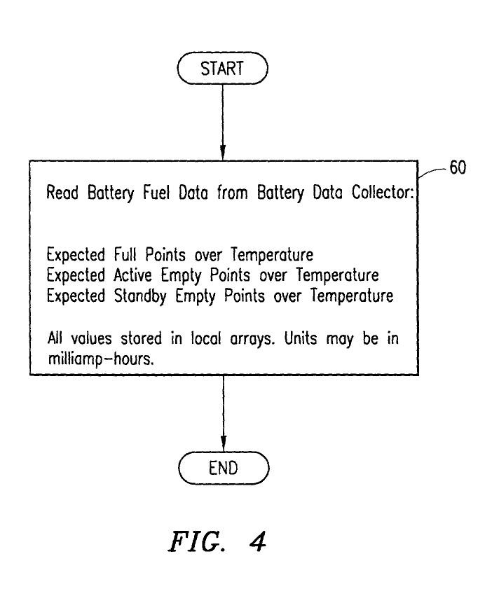

Referring to FIG. 4, a step 60, FPINIT initializes all the variables to be used by the other four tasks of fuel gauge algorithm 37 before the battery fuel data 36 is transferred from the battery data collector 35 so that the variables will not cause an error in later calculations. These variables include, but are not limited to, expected full points over temperature, expected active empty points over temperature, and expected standby empty points over temperature. The values for these variables may, but do not necessarily have to be, stored in local arrays in units of milliamp-hours. If at any time there is an error initializing the variables in FPINIT, FPINIT returns an error message to the main program.

Turning back to FIG. 3, while cell phone 20 is turned on, the task FPUPDATE can be called by the main program as needed to update battery fuel information. Depending on programming needs, FPUPDATE can be periodically and automatically called by the main program, can be called by the user, or can be called an unlimited amount of times before the cell reaches the battery empty point.

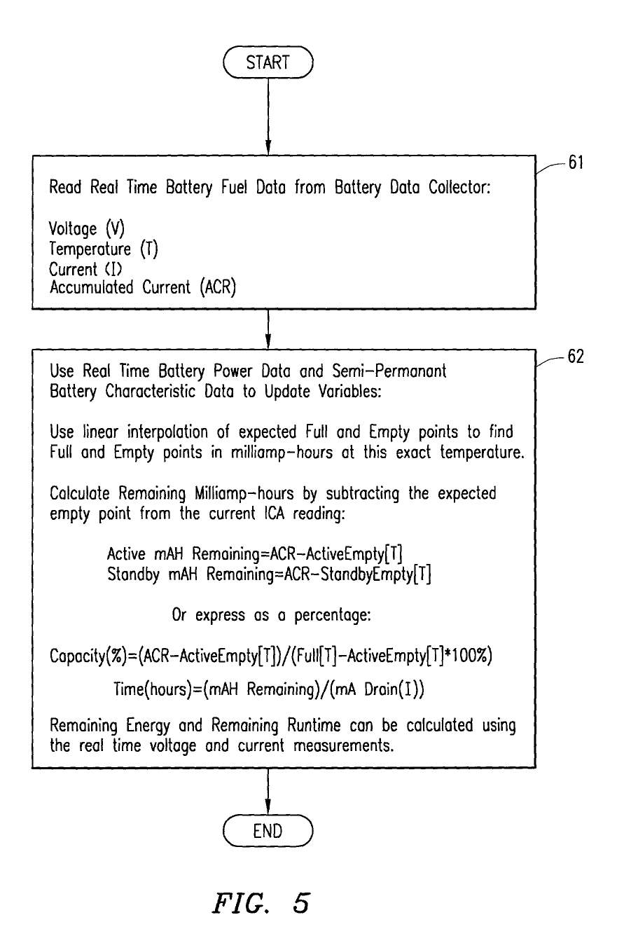

Referring to FIG. 5, FPUPDATE reads battery fuel cell data 36 transmitted from battery data collector 35 and calculates from the battery fuel cell data 36 various battery power information such as, but not limited to, remaining milliamps-hours, remaining energy in joules, and remaining standby/active runtime. At step 61, various battery fuel cell data 36 is read from battery data collector 35. The battery fuel cell data 36 includes, but is not limited to, voltage, temperature, current, and accumulated current (ACR). Then, at step 62, these battery power information can be calculated using linear interpolation of between two expected battery full and/or empty points, both stored as the semi-permanent battery characteristic data, to find the full and empty points at a specified temperature (remaining battery power is temperature dependant). The remaining milliamp hours is then calculated by subtracting the expected empty point from the current reading. The remaining energy and remaining runtime can then be calculated using the real time voltage and current measurements in accordance with familiar equations known to those skilled in the art The battery power information calculated can be passed to the main program for display or can be displayed immediately after the calculation of the information without first passing the information to the main program. If an error occurs at any time during the reading or calculation of battery data information, FPUPDATE returns an error message to the main program.

Referring back to FIG. 3, FPEMPTY may be called just before cell phone 20 completely shuts down due to reaching the battery empty point.

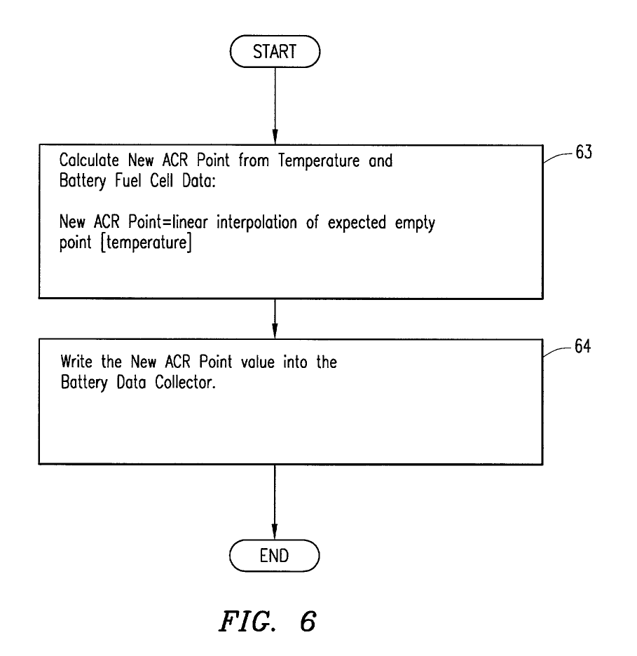

Referring now to FIG. 6, FPEMPTY resets the ACR to the expected empty point for a particular temperature. The reset is necessary to adjust for errors in the current accumulator due to factors such as quantization errors in the current measurement. Preferably, though not required, FPUPDATE is called just prior to FPEMPTY to increase the accuracy in estimating the power management system 30 temperature. FPEMPTY should preferably not be called under extreme temperature conditions when rechargeable cells tend to act unpredictably, causing erroneous readings to the data collector 35. When FPEMPTY is called, at step 63, the new expected empty point for that temperature is the linear interpolation of the expected empty points between the new expected empty point and another expected empty point at the next temperature increment. After this new accumulated current value is calculated, at step 64, the new value replaces the old ACR. If an error occurs at any time during the calculation of data in FPEMPTY, FPEMPTY returns an error message to the main program.

Referring back to FIG. 3, FPFULL can be called just after the battery pack 22 is charged from partially empty to the battery full point.

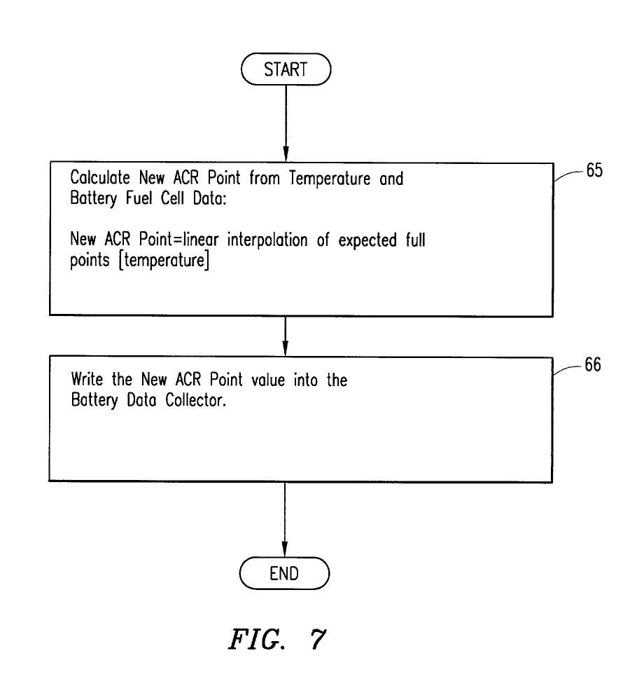

Referring to FIG. 7, FPFULL resets the ACR to the expected full point for a particular temperature. When the main program determines that a full charge has been reached, it can call either FPFULL or FPLEARN (FPLEARN will be discussed in further detail below). FPFULL is the standard routine that is called most of the time. The reset is necessary to adjust for errors in the current accumulator due to factors such as quantization errors in the current measurement. For best accuracy, FPUPDATE should (but does not necessarily have to be) run just prior to FPFULL for an accurate estimation of the battery pack 32 temperature. Preferably, PFFULL is not called under extreme temperature conditions when rechargeable cells tend to act unpredictably. The new expected full point for that temperature is calculated at step 65 and is the linear interpolation of the expected full points between the new expected full point and another expected full point at the next temperature increment. At step 66, this new accumulated current value then replaces the old ACR. If at any time an error occurs in the operation of FPFULL, FPFULL returns an error message to the main program.

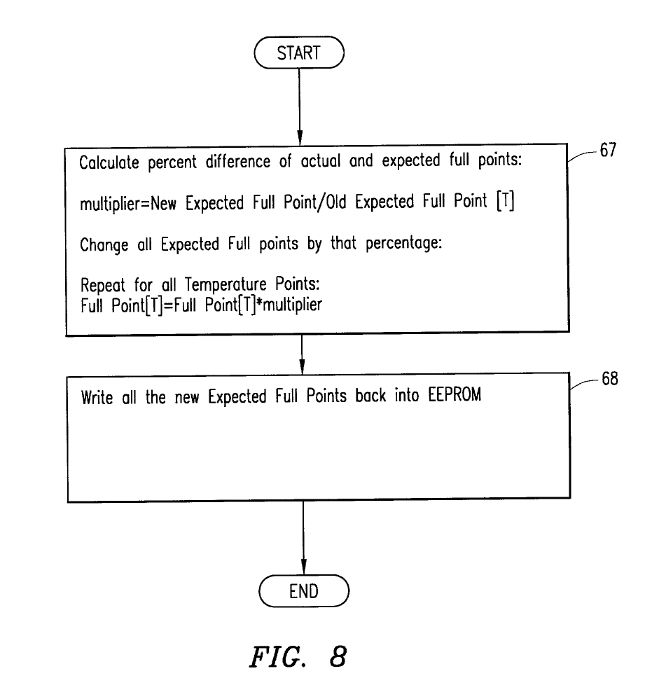

Referring back to FIG. 3, FPLEARN is called when the accumulated charge reading is believed to be most accurate, generally when charging from an expected empty point to an expected full point. Unlike FPFULL, FPLEARN resets the expected full point stored as semi-permanent characteristic data in battery collector 35. Instead of adjusting ACR to existing data, FPLEARN adjusts all expected full points for the entire range of temperatures to the ACR. To do so, as shown in FIG. 8 at step 67, after calculating the new expected full point by using the interpolation method already described above, a multiplier is obtained by dividing the new expected full point by the old expected full point at that temperature The multiplier is then used to adjust all the expected full points for all temperatures. Finally, at step 68, the newly adjusted expected full points are stored in the battery data collector 35 as semi-permanent characteristic data. While FPLEARN can be called at any time, it is preferably called when a user is most confident in the fuel gauge reading The recommended best time would be after a complete, uninterrupted charge from completely empty to completely full at room temperature.

Referring back to FIG. 3, an overall description of the battery data update process is as follows. At step 40, cell phone 20 is turned on. Sometime after cell phone 20 is turned on but before any of the other four tasks of fuel gauge algorithms 37 are called, the main program calls FPINIT at step 41. After FPINIT is called, the main software may enter into a loop at step 42 so that FPUPDATE can be repeatedly called at step 43. After FPUPDATE is called and while still in the loop, the main program determines at step 44 whether battery pack 22 is completely drained. If battery pack 22 is completely drained, then the main program calls FPEMPTY at step 45. If step 45 is called, the main program exits the loop at step 46 because cell phone 20 is then completely and automatically shut down due to lack of battery power. If battery pack 22 is not completely empty, the main program checks at step 47 whether there has been a partial charge of battery pack 22. If there has been a partial charge at step 47, then the main program calls FPFULL at step 48. If there has been no partial charge at step 47, then at step 49 the main program determines whether there has been a full charge of battery pack 22. If there has been a full charge, then the main program calls FPLEARN at step 50. If there has been no full charge at step 49, then at step 51 the main program determines whether or not the loop is to continue. If the loop is to continue at step 51, then the main program goes back to the beginning of the loop at step 42. If the loop is not to be continued, then the loop ends at step 46.

Although a preferred embodiment of the system and method of the present invention has been illustrated in the accompanying drawings and described in the foregoing detailed description, it should be understood that the invention is not limited to the embodiment disclosed, but is capable of numerous rearrangements, modifications, and substitutions without departing from the spirit of the invention as set forth and defined by the followings claims.

What is claimed is:

1. Computer-executable instructions for determining active and standby battery power information, said computer-executable instructions comprising:
a first program code for initializing at least one variable for use in performing calculations in said computer-executable instructions;
a second program code for reading raw electrical power data collected by a battery data collector and converting said raw electrical power data to active and standby battery information, said second program code using said at least one variable initialized by said first program code to read and convert said raw electrical power data;
a third program code for resetting a battery fuel gauge data to zero, said battery fuel gauge data a part of said raw electrical power data, said third program code called before said computer-executable instructions terminate as a result of full battery power drainage;
a fourth program code for resetting said battery fuel gauge data to completely full, said fourth program code called after said raw electrical power data indicate a battery power charge from partially empty to completely full; and
a fifth program code for resetting an expected battery full reading, said expected battery full reading a part of said raw electrical power data, said fifth program code called after said raw electrical power data indicate a battery power charge from completely empty to completely full.

2. Computer-executable instructions as in claim 1 wherein said first program code, said second program code, said third program code, said fourth program code, and said fifth program code return an error message if an error occurs in the operation of said computer-executable instructions.

3. Computer-executable instructions as in claim 1 wherein said first program code, said second program code, said third program code, said fourth program code, and said fifth program code are a part of one single function that can be called from a main program code.

4. Computer-executable instructions as in claim 1 wherein said first program code, said second program code, said third program code, said fourth program code, and said fifth program code are separate functions that can be called from a main program code.

5. A battery power management system for a battery powered device, comprising:
a system processor;
a fuel gauge algorithm, said fuel gauge algorithm running on said system processor;
at least one battery fuel cell electrically connected to said system processor; and
a battery data collector electrically connected to said battery fuel cell, said battery data collector collects electrical power data from said battery fuel cell and transmits said electrical power data to said fuel gauge algorithm, where said fuel gauge algorithm converts said electrical power data to battery power information.

6. The battery power management system of claim 5 wherein said battery powered device is a cell phone.

7. The battery power management system of claim 5 wherein said battery powered device is a personal digital assistant.

8. The battery power management system of claim 5 wherein said battery powered device is an MP3 player.

9. The battery power management system of claim 5 wherein said battery powered device is a hand-held computing device.

10 The battery power management system of claim 5 wherein said battery powered device is an electric vehicle.

11. The battery power management system of claim 5 wherein said battery data collector is Dallas Semiconductor's DS2760 High Precision Li-Ion Battery Monitor.

12. The battery power management system of claim 5 wherein said battery fuel cell is rechargeable.

13. The battery power management system of claim 5 wherein said battery fuel cell is disposable.

14. The battery power management system of claim 5 wherein said battery fuel cell is detachably attached to said portable product portion.

15. The battery power management system of claim 5 wherein said battery power information is displayed on a display unit.

16. The battery power management of claim 5 wherein said battery power information is displayed in units of time.

17. The battery power management system of claim 15 wherein measurement units associated with said battery power information change in accordance with a preset scheme.

18 A battery power management system, comprising:
a portable product portion, comprising:
a system processor;
a fuel gauge algorithm, running on said system processor;
a battery pack portion, comprising:
at least one battery fuel cell electrically connected to said portable product portion; and
a battery data collector electrically connected to said battery fuel cell, said battery data collector collects electrical power data from said battery fuel cell and transmits said electrical power data to said fuel gauge algorithm.

19 The battery power management system of claim 18 wherein said portable product portion is a cell phone.

20 The battery power management system of claim 18 wherein said portable product portion is a personal digital assistant.

21. The battery power management system of claim 18 wherein said portable product portion is an MP3 player

22. The battery power management system of claim 18 wherein said portable product portion is a hand-held computing device

23. The battery power management system of claim 18 wherein said portable product portion is an electric vehicle

24. The battery power management system of claim 18 wherein said fuel gauging algorithm calculates active battery power information.

25. The battery power management system of claim 24 wherein measurement units associated with said active battery power information change in accordance with a present scheme.

26. The battery power management system of claim 18 wherein said fuel gauging algorithm calculates standby battery information.

27. The battery power management system of claim 26 wherein measurement units associated with said standby battery power information change in accordance with a present scheme.

28. The battery power management system of claim 18 wherein said battery data collector is Dallas Semiconductor's DS2760 High Precision Li-Ion Battery Monitor.

29. The battery power management system of claim 18 wherein said battery fuel cell is rechargeable.

30. The battery power management system of claim 18 wherein said battery fuel cell is disposable.

31. The battery bower management system of claim 18 wherein said battery pack portion is detachably attached to said portable product portion.

32. A method of managing battery power in a battery powered device, comprising the steps:
collecting battery fuel cell power information using a battery data collector, said battery data collector electrically connected to at least one battery fuel cell;
transmitting said battery fuel cell power information from said battery data collector to a system processor on said battery powered device; and
converting said battery fuel cell power information into battery power information.

33. The method of managing battery power for a battery powered device as in claim 32 comprising the additional step of displaying said battery power information after said converting step.

34. The method of managing battery power for a battery powered device as in claim 33 wherein measurement units associated with said battery power information change in accordance with a preset scheme.

35. The method of managing battery power for a battery powered device as in claim 32 wherein said electric cell is detachably attached to said battery powered device.

36. The method of managing battery power for a battery powered device as in claim 32 wherein said battery powered device is a cell phone.

37. The method of managing battery power for a battery powered device as in claim 32 wherein said battery powered device is a personal digital assistant.

38. The method of managing battery power for a battery powered device as in claim 32 wherein said battery powered device is an MP3 player.

39. The method of managing battery power for a battery powered device as in claim 32 wherein said battery powered device is a hand-held computing device.

40. The method of managing battery power for a battery powered device as in claim 32 wherein said battery powered device is an electric vehicle.

41. The method of managing battery power in a battery powered device as in claim 32 wherein said battery data collector is Dallas Semiconductor's DS2760 High Precision Li-Ion Battery Monitor.

42. The method of managing battery power in a battery powered device as in claim 32 wherein said battery fuel cell is rechargeable.

43 The method of managing battery power in a battery powered device as in claim 32 wherein said battery fuel cell is disposable.
